(19) United States
(12) Patent Application Publication
(10) Pub. No.: US 2024/0373217 A1
(43) Pub. Date: Nov. 7, 2024

(54) SYSTEMS AND METHODS FOR INTERNET PROTOCOL ADDRESS DELEGATION BASED ON USER EQUIPMENT INFORMATION

(71) Applicant: Verizon Patent and Licensing Inc., Basking Ridge, NJ (US)

(72) Inventors: Jerry Steben, Forth Worth, TX (US); Shanthala Kuravangi-Thammaiah, Keller, TX (US); Violeta Cakulev, Milburn, NJ (US); Suzann Hua, Beverly Hills, CA (US)

(73) Assignee: Verizon Patent and Licensing Inc., Basking Ridge, NJ (US)

(21) Appl. No.: 18/312,622

(22) Filed: May 5, 2023

(51) Int. Cl. H04W 12/06; H04W 12/69

(52) U.S. Cl. CPC H04W 12/06; H04W 12/69

(57) ABSTRACT

A system described herein, such as an Session Management Function (“SMF”) of a core network of a wireless network, may receive a request to associate a particular User Equipment (“UE”) with a plurality of Internet Protocol (“IP”) addresses. The UE may be associated with a communication session between the UE and the core network. The system may output an information request for IP address authorization information from a UE information repository associated with the wireless network, and may receive a response to the information request from the UE information repository. The system may identify a quantity of IP addresses based on the response to the information request, and may provide the identified quantity of IP addresses to the particular UE in response to the request to associate the particular UE with the plurality of IP addresses.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Fixed Wireless Access (“FWA”) devices may connect to a wireless network, and may provide connectivity to other devices that connect to the FWA devices. FWA devices may include, for example, routers, switches, hubs, gateways, etc. that are wirelessly communicatively coupled to a wireless network and that serve connectivity to UEs, routers, or other devices via a wireless or wired interface. Wireless networks may, in some instances, provide Internet Protocol (“IP”) addresses or pools of IP addresses that FWA devices may provide (e.g., delegate) to devices that receive connectivity through the FWA devices.

### BRIEF DESCRIPTION OF THE DRAWINGS

FIGS. 1-3 illustrate an example overview of one or more embodiments described herein;

FIGS. 4 and 5 illustrate example signal flows for elements of a core network providing IP addresses based on IP address authorization information, in accordance with some embodiments;

FIG. 6 illustrates an example process for providing IP addresses based on IP address authorization information, in accordance with some embodiments;

FIGS. 7 and 8 illustrate example environments in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

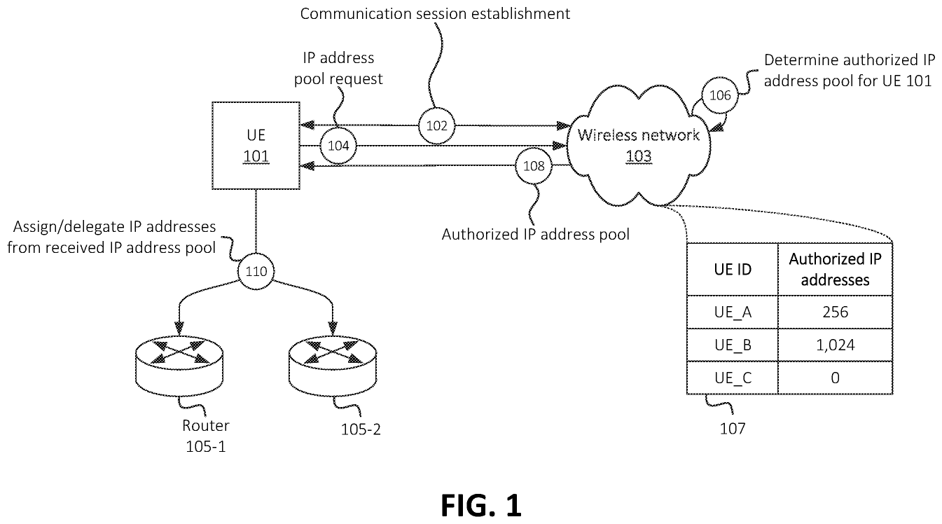

Embodiments described herein provide for a core network-based authorization verification procedure for providing IP addresses to devices that are connected to a wireless network that includes a RAN and a core network. For example, as shown in FIG. 1, UE 101 may be wirelessly connected to wireless network 103. In some embodiments, UE 101 may be, may include, may implement, and/or may be associated with an FWA device that is communicatively coupled to one or more other devices, such as one or more routers 105 (i.e., routers 105-1 and 105-2, in this example), one or more other UEs, or other types of devices. In some embodiments, UE 101 may be or may implement another type of device (e.g., other than an FWA device) that is communicatively coupled (either wirelessly or via a wired interface) to routers 105 and/or other devices or systems. While UE 101 is described as being communicatively coupled to routers 105-1 and 105-2 for the sake of brevity, similar concepts as described herein may apply to other quantities or types of devices that are communicatively coupled to UE 101.

As shown, UE 101 and wireless network 103 may establish (at 102) a communication session, which may include establishing one or more radio bearers (e.g., between UE 101 and a RAN of wireless network 103) and/or one or more IP-based communication sessions (e.g., one or more protocol data unit (“PDU”) sessions or other suitable types of communication session) between UE 101 and a core of wireless network 103. The IP-based sessions may include or may be associated with one or more tunnels, such as GPRS Tunneling Protocol (“GTP”)-U tunnels between UE 101 and one or more elements of the core network, such as one or more User Plane Function (“UPFs”), Packet Data Network (“PDN”) gateways (“PGW”), etc. A given tunnel may be associated with Tunnel Endpoint Identifiers (“TEIDs”), which may identify UE 101 and the UPF, PGW, etc. of wireless network 103 as endpoints of the tunnel. As discussed herein, UE 101 may be associated with one or more IP addresses, which may be maintained by elements of the core network such that traffic directed to such IP addresses may be routed to UE 101 via a suitable tunnel. For example, a UPF, PGW, or other suitable element of the core network may maintain information associating such IP addresses with a particular tunnel and/or with UE 101. In this manner, UE 101 and/or corresponding tunnels between UE 101 and wireless network 103 may have a many-to-one relationship with IP addresses (e.g., multiple IP addresses may be associated with UE 101, and/or multiple IP addresses may be associated with a particular tunnel between UE 101 and wireless network 103).

UE 101 may provide or delegate some of the IP addresses to devices that are connected to UE 101, such as routers 105-1 and 105-2, other UEs, and/or other types of devices. For example, wireless network 103 may assign, provide, etc. a pool of IP addresses (e.g., multiple IP addresses, such as IPv6 addresses, IPv6 address prefixes, etc.) to UE 101, and UE 101 may assign (e.g., delegate) a first subset of these IP addresses to router 105-1 and may assign a second subset of these IP addresses to router 105-2. Wireless network 103 may accordingly route traffic to router 105-1, through UE 101, using the first subset of IP addresses and may route traffic to router 105-2, through UE 101, using the second subset of IP addresses. Further, routers 105 may be “cascading” routers in instances where UE 101 serves as a router between routers 105 and wireless network 103. For example, other devices (e.g., other UEs, other routers, and/or other types of devices) may receive connectivity to wireless network 103 via UE 101 and routers 105-1 and/or 105-2.

In accordance with some embodiments, UE 101 may request (at 104) a pool of IP addresses from wireless network 103. For example, in some embodiments, UE 101 may request a particular quantity of IP addresses, which may include specifying a requested prefix length (e.g., an IPV6 prefix length). In some embodiments, the request (at 104) may be or may include a prefix delegation request (e.g., an IPv6 prefix delegation request). In accordance with some embodiments, one or more elements of wireless network 103 (e.g., an element of a core of wireless network 103) may determine (at 106) whether UE 101 is authorized to receive the requested IP address pool (e.g., the requested quantity of IP addresses), and/or may otherwise determine a quantity of IP addresses for which UE 101 is authorized.

In some embodiments, different UEs and/or groups of UEs may be associated with different authorized quantities of IP addresses. Further, wireless network 103 may track a quantity of IP addresses that have been assigned, granted, etc. to different UEs, and may accordingly track how many IP addresses remain available for such UEs on a per-UE basis. Data structure 107 represents an example of such information that may be maintained by one or more elements of wireless network 103 (e.g., one or more elements of a core of wireless network 103). As shown, for example, data structure 107 may include an identifier of respective UEs, such as a Subscription Permanent Identifier (“SUPI”), a Globally Unique Temporary Identifier (“GUTI”), an International Mobile Station Equipment Identity (“IMEI”), an International Mobile Subscriber Identity (“IMSI”), a Mobile Directory Number (“MDN”), a TEID, and/or other suitable identifier. Data structure 107 may further indicate a quantity of IP addresses for which each UE is authorized, which may reflect a total quantity of authorized IP addresses, a total remaining quantity of authorized IP addresses (e.g., in scenarios where some IP addresses have already been assigned to such UEs), a quantity of IP addresses that have been assigned to such UEs, and/or other suitable information.

In some embodiments, the authorized quantity of IP addresses may be received from a provisioning system, an administrator, and/or some other suitable device or system associated with wireless network 103. In some embodiments, elements of wireless network 103 may track a quantity of IP addresses assigned to respective UEs, and may automatically update data structure 107 based on such tracking.

Assuming that wireless network 103 has determined (at 106) that some or all of the requested IP addresses should be granted, wireless network 103 may generate or select a particular IP address pool. Such IP address pool may correspond to the requested quantity of IP addresses (e.g., if such quantity is available for UE 101), or may correspond to a different quantity. For example, in some embodiments, the provided (at 108) IP addresses may be greater than the requested quantity, such as all authorized IP addresses for UE 101, or some other quantity that is greater than the requested quantity. Wireless network 103 may provide more IP addresses in situations where a total quantity of IP addresses available for assignment by wireless network 103 is greater than a threshold quantity (e.g., wireless network 103 has a relatively large amount of available IP addresses), and may be thereby provided in order to provide “headroom” or “cushion” above what was requested by UE 101, to potentially avoid situations in which UE 101 may subsequently request more IP addresses. On the other hand, in some situations, wireless network 103 may provide (at 108) fewer IP addresses than requested, such as situations where the request exceeds the amount of authorized IP addresses for UE 101, and/or in situations where a total quantity of IP addresses available for assignment by wireless network 103 is below a threshold (e.g., wireless network 103 is running out of available IP addresses).

As discussed above, UE 101 may assign or delegate (at 110) different subsets of the received (at 108) IP addresses to devices that are communicatively coupled to UE 101, such as routers 105-1 and 105-2 (e.g., cascading routers) and/or other devices or systems. Delegating such IP addresses to routers 105 may allow for routers 105 to further assign or delegate the IP addresses to other devices that connect to such routers 105. For example, routers 105 may perform Dynamic Host Configuration Protocol (“DHCP”) techniques or other suitable techniques to delegate, distribute, assign, etc. such IP addresses. By virtue of the delegation of particular subsets of the received (at 108) IP addresses to routers 105-1 and 105-2, routers 105-1 and 105-2 may be able to communicate with wireless network 103 using such IP addresses. For example, wireless network 103 may be able to route traffic to routers 105-1 and/or 105-2 via respective IP addresses that have been delegated to routers 105-1 and/or 105-2.

In some embodiments, UE 101 may issue multiple IP address pool requests (e.g., IP delegation requests) and receive IP addresses or IP address pools in response to such requests, such as in situations to update a network topology associated with UE 101, which may include the addition or removal of routers 105 or other devices connected to UE 101, the addition or removal of devices or systems connected to routers 105, etc. Since such requests are performed independently of the communication session establishment (at 102), IP address pools associated with UE 101 may be able to be assigned dynamically and independently of the establishment (at 102) of such communication sessions, thereby providing greater flexibility.

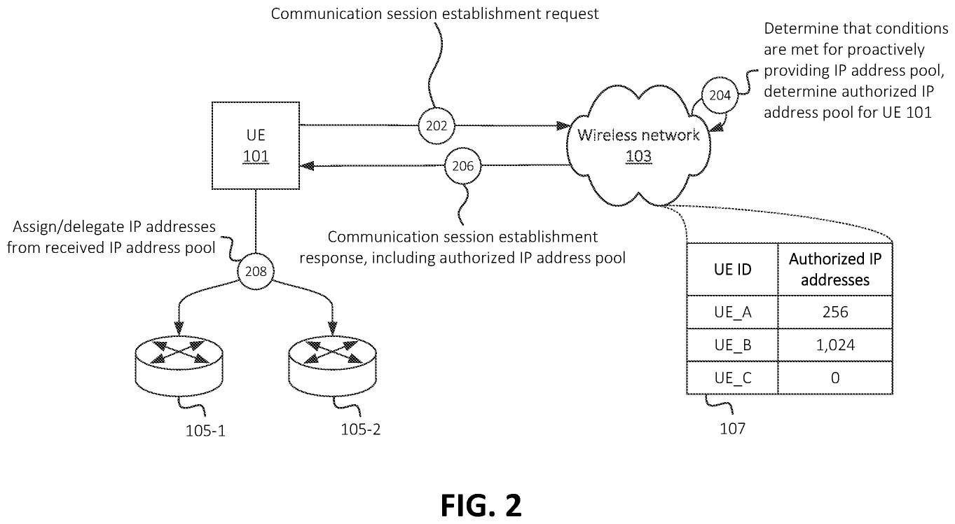

FIG. 2 illustrates another example of providing an authorized pool of IP addresses to a given UE 101. As discussed above, UE 101 may be or may include a FWA device. In some embodiments, UE 101 may be or may include another type of device that provides connectivity to other devices, such as a mobile phone, a tablet, a router, etc. As shown, UE 101 may output (at 202) a communication session establishment request. The communication session establishment request may be or may include a PDU session request or other IP-based communication session request. For example, the communication session request may be provided to a UPF of a core of wireless network 103, a PGW of the core of wireless network 103, etc. The request may be provided via a RAN of wireless network 103.

In this example, based on receiving the communication session establishment request, wireless network 103 may determine (at 204) that conditions are met for proactively providing an IP address pool to UE 101. For example, even in situations where the communication session request does not include a request for IP addresses (e.g., an IP delegation request), wireless network 103 may nevertheless determine that an IP address pool should be provided to UE 101. For example, wireless network 103 may utilize artificial intelligence/machine learning (“AI/ML”) techniques, such as predictive models, to identify that UE 101 is likely to request an IP address pool (e.g., based on a device type of UE 101, a location of UE 101, a predicted or determined presence of other devices within a threshold proximity of UE 101, etc.). Additionally, or alternatively, wireless network 103 may identify that a quantity of available IP addresses for wireless network 103 exceeds a threshold quantity (e.g., wireless network 103 may have a relatively large quantity of IP addresses available to assign). In some embodiments, wireless network 103 may identify one or more other factors or conditions to determine that an IP address pool should be provided to UE 101 based on the communication session establishment request (e.g., without an explicit request from UE 101 for such IP addresses).

As similarly discussed above, wireless network 103 may select a particular quantity of IP addresses to provide to UE 101, which may be a maximum authorized quantity of IP addresses for UE 101 (e.g., as indicated in data structure 107) or some other suitable quantity. Wireless network 103 may, in conjunction with establishing the requested communication session, provide (at 206) the IP addresses to UE 101. Wireless network 103 may also configure elements of wireless network 103, such as a UPF or PGW, to associate the communication session and/or an identifier of UE 101 with the provided IP addresses. In some embodiments, wireless network 103 may include the IP addresses in a communication session establishment response or acknowledgement message (e.g., as an information element (“IE”) in such message), or may provide the IP addresses to UE 101 via some other suitable message or messages. UE 101 may accordingly assign and/or delegate (at 208) respective subsets of the received IP addresses to router 105-1, router 105-2, and/or other suitable devices or systems that are communicatively coupled to UE 101.

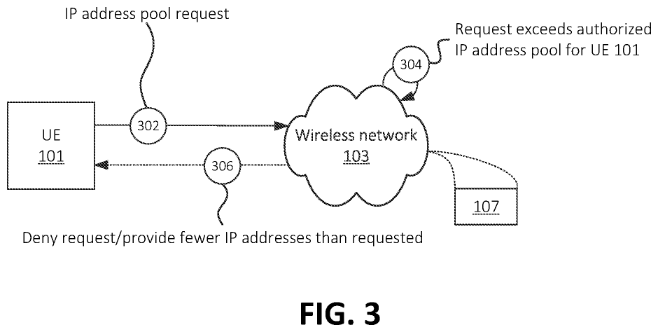

FIG. 3 illustrates an example in which an IP address pool request exceeds an IP address authorization for a given UE 101. As shown, UE 101 may output (at 302) an IP address pool request, which may specify a particular quantity of IP addresses. Wireless network 103 may determine (at 304), based on data structure 107 and/or other suitable information, that the request exceeds an authorized IP address pool for UE 101. For example, UE 101 may have already received a maximum quantity of IP addresses, wireless network 103 may not have IP addresses available to provide to UE 101, UE 101 may be requesting more IP addresses than for which UE 101 is authorized, etc. Wireless network 103 may accordingly deny (at 306) the request, such as by providing no IP addresses, or may provide (at 306) fewer than the requested quantity of IP addresses. In this manner, a situation may be prevented in which a relatively numerous (e.g., millions, billions, etc.) quantity of IP addresses are provided in response to a malicious, unintentional, or otherwise undesirably large request for IP addresses.

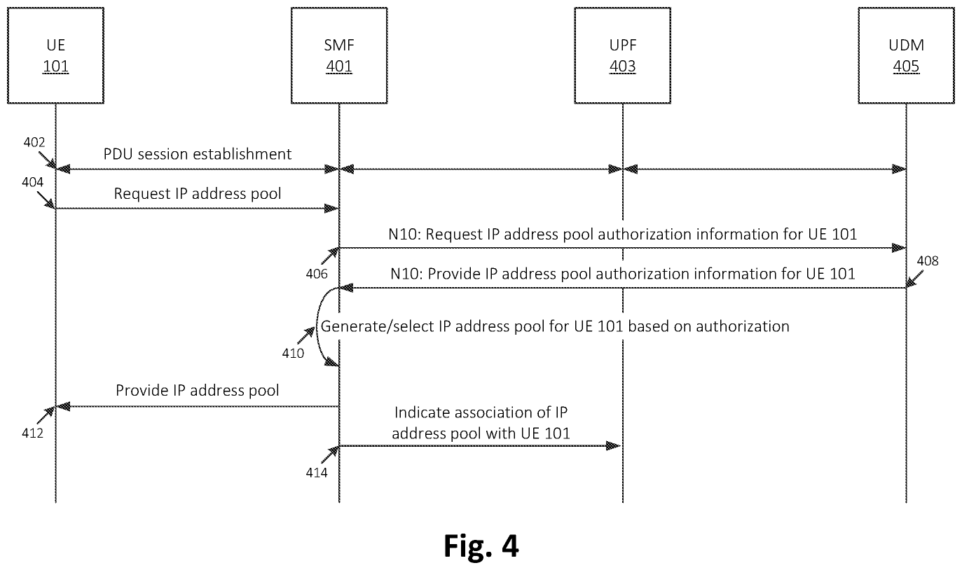

FIG. 4 illustrates an example signal flow for providing an IP address pool to UE 101, as performed by particular elements of wireless network 103. Such elements may be elements of a core of wireless network 103, such as Session Management Function (“SMF”) 401, UPF 403, and Unified Data Management function (“UDM”) 405. In some embodiments, other elements of wireless network 103 may perform some or all of the operations described with respect to SMF 401, UPF 403, and UDM 405.

As shown, UE 101, SMF 401, UPF 403, and UDM 405 may perform (at 402) a PDU session establishment procedure, in which one or more PDU sessions are established between UE 101 and UPF 403. The PDU session may be established based on a request from UE 101 and/or some other suitable device or system, such as an application server or other device that outputs a request to communicate with UE 101. In some embodiments, the PDU session establishment may involve one or more other devices or systems, such as an Access and Mobility Management Function (“AMF”) or other devices or systems. The PDU session establishment procedure may include outputting, forwarding, receiving, etc. one or more messages, such as an Nsmf_PDUSession_CreateSMContext Request, an Nsmf_PDUSession_CreateSMContext Request response, a Session Management Subscription Data Retrieval message (e.g., via an N10 interface between SMF 401 and UDM 405, and/or other suitable messages. Further, the PDU session establishment may include communications with one or more other network elements, such as a Policy Control Function (“PCF”), in order to obtain policies or other information associated with the requested PDU session. Establishing the PDU session may include associating UE 101 and UPF 403 with one or more tunnels, such as GTP-U tunnels, via which communications between UE 101 and UPF 403 (e.g., associated with the PDU session) may be routed. SMF 401, UPF 403, and/or other elements of the core network may maintain information associating UE 101, UPF 403, and/or the PDU session with the one or more tunnels.

UE 101 may further request (at 404) an IP address pool (e.g., a set of IP addresses), which may include specifying a quantity of requested IP addresses. In some embodiments, the request (at 404) may indicate that the request is associated with the particular PDU session (e.g., may include a PDU session identifier, tunnel identifier, or other suitable identifier). In this manner, different requests (e.g., other iterations of the request at 404) may refer to different PDU sessions, and ultimately different PDU sessions may be associated with different IP address pools.

In some embodiments, the request may be received (at 404) by SMF 401. In some embodiments, UE 101 may output the request to one or more other devices (e.g., to an AMF via Non-Access Stratum (“NAS”) signaling), which may forward the request to SMF 401. As discussed above, the request may be an IPV6 prefix delegation request or other suitable type of request.

In accordance with some embodiments, based on receiving the request (at 404) for IP addresses associated for UE 101, SMF 401 may request (at 406) IP address authorization information associated with UE 101. For example, the request may be output to UDM 405 via an N10 interface (e.g., an interface between SMF 401 and UDM 405), an Nudm interface, or other suitable communication pathway. As discussed above. UDM 405 may maintain information indicating a quantity of IP addresses (e.g., an IP prefix length and/or a quantity of IP prefixes) for which UE 101 is authorized. In some embodiments, UDM 405 may maintain other suitable information, such as whether UE 101 is associated with static or dynamic IP addresses. For example, when UE 101 is associated with static IP addresses, particular IP addresses may be reserved for UE 101 and may not be assigned to other devices or systems. In some embodiments, UDM 405 may maintain information associating UE 101 with one or more external authorization systems, such as an enterprise system (e.g., may include a Uniform Resource Locator (“URL”), Uniform Resource Identifier (“URI”), and/or other suitable communication information associated with the external authorization systems). In such embodiments, SMF 401 may further communicate with such external authorization systems when determining whether to provide the requested IP addresses to UE 101.

UDM 405 may provide (at 408) the requested IP address authorization information for UE 101 to SMF 401 (e.g., via the N10 interface, via an Nsmf interface, etc.). SMF may generate and/or select (at 410) a particular IP address pool for UE 101 based on the received authorization information and the request. For example, SMF 401 may generate or select a quantity of requested IP addresses, or may generate or select a lesser or greater quantity of IP addresses based on factors or conditions discussed above. In the event that UE 101 is associated with a static set of IP addresses (e.g., as indicated by UDM 405), SMF 401 may select some or all of the static set of IP addresses to fulfill the request.

SMF 401 may further provide (at 412) the requested IP addresses to UE 101. For example, in some embodiments, SMF 401 may provide the IP addresses to an AMF via an N1N2 message, and the AMF may forward the IP addresses to UE 101 via NAS signaling. In some embodiments, SMF 401 may provide the IP addresses to UE 101 via some other suitable communication pathway. Additionally, in some embodiments, SMF 401 may output (at 414) an indication to UPF 403, with which the PDU session is associated, that UE 101 and/or the particular PDU session is associated with the selected pool of IP addresses. In this manner, UPF 403 may maintain information associating UE 101 with the IP address pool, and may be able to appropriately route communications to UE 101 (e.g., via the PDU session) using such IP addresses. Additionally, as discussed above, UE 101 may use the received IP addresses by delegating or assigning such IP addresses to other devices that are connected to UE 101, such as cascading routers (e.g., routers 105), other UEs, etc. In this manner, UE 101 may be able to serve multiple networks, subnets, etc., that are associated with the received IP addresses and are ultimately able to receive connectivity via wireless network 103 through UE 101.

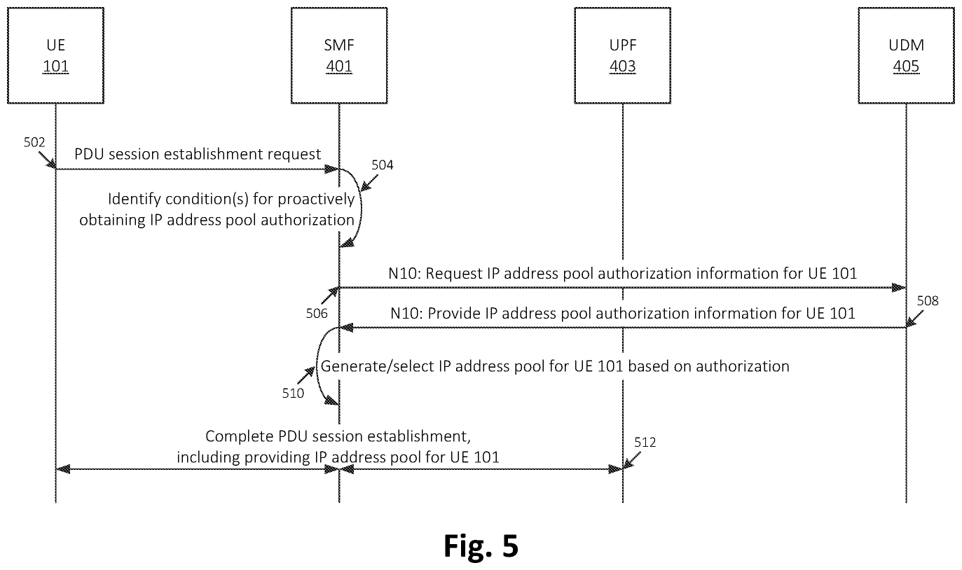

FIG. 5 illustrates another example signal flow for providing an IP address pool to UE 101, as performed by particular elements of wireless network 103. As discussed above, an IP address pool may be provided to UE 101 as part of, or in conjunction with, a PDU session establishment. As shown, for example, UE 101 may request (at 502) a PDU session establishment, or SMF 401 may otherwise receive a PDU session establishment request for UE 101 (e.g., one or more other devices may request the PDU session establishment, such as an application server or another UE that requests to communicate with UE 101). In some embodiments, the request (at 502) may not include a request for IP addresses (e.g., may not be or may not include an IP delegation request or other type of request for IP addresses for UE 101). SMF 401 may identify (at 504) one or more conditions for proactively obtaining an IP address pool authorization for UE 101. For example, as discussed above, SMF 401 may utilize AI/ML techniques to identify that UE 101 is likely to request a set of IP addresses, may identify that a total IP address capacity (e.g., unused IP addresses) of wireless network 103 exceed a threshold capacity, and/or that other suitable conditions are met. Accordingly, SMF 401 may output (at 506) a request for IP address pool authorization information associated with UE 101 (e.g., via an N10 message). In some embodiments, the request (at 506) may be provided as a flag or IE in another message sent pursuant to the PDU session establishment request, such as a Session Management Subscription Data Retrieval message. In this manner, the request for IP address pool authorization information may not necessitate additional messaging between SMF 401 and UDM 405, beyond what is already performed for the PDU session establishment.

SMF 401 may receive (at 508) the requested IP address pool authorization information from UDM 405, which may be received along with other information used for indicating authorization of or otherwise establishing or the PDU session (e.g., subscriber information and/or other suitable information). For example, the same message or set of messages that include the subscriber information from UDM 405 may also include an indication of a quantity of IP addresses for which UE 101 is authorized (e.g., an IPv6 prefix length and/or prefix quantity), an indication of whether such IP addresses are static or dynamic, an indication of an external authorization system, and/or other suitable information as discussed above. SMF may accordingly generate or select (at 510) a particular pool of IP addresses for UE 101 based on identifying (at 504) the conditions for proactively providing the IP addresses to UE 101, and further based on the subscriber and/or IP address authorization information received (at 508) from UDM 405.

SMF 401 may select a particular UPF 403 for the PDU session, and may facilitate (at 512) the completion of the PDU session establishment, which may include providing a PDU session identifier to UPF 403 and UE 101, providing an identifier of an associated tunnel to UPF 403 and UE 101, and/or other suitable operations. As discussed above, SMF 401 may also provide the requested IP addresses to UE 101 and UPF 403, such that UE 101 may delegate the IP addresses to other devices, which may communicate with UPF 403 (e.g., via UE 101) using the IP addresses.

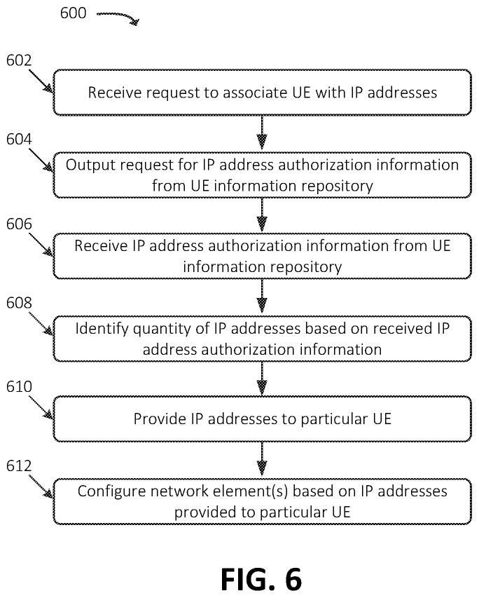

FIG. 6 illustrates an example process 600 for providing IP addresses based on IP address authorization information, in accordance with some embodiments. In some embodiments, some or all of process 600 may be performed by SMF 401. In some embodiments, one or more other devices may perform some or all of process 600 in concert with, and/or in lieu of, SMF 401.

As shown, process 600 may include receiving (at 602) a request to associate a particular UE 101 with a multiple IP addresses. For example, as discussed above, SMF 401 may receive a prefix delegation request and/or some other type of request to associate UE 101 with a pool or set of IP addresses. In some embodiments, the request may be received after a PDU session or other suitable communication session has been established between UE 101 and a core of wireless network 103. In some embodiments, the request may be received in conjunction with, or may be implicitly identified (e.g., based on the satisfaction of one or more conditions, as discussed above) by SMF 401 based on, a PDU session establishment request.

Process 600 may further include outputting (at 604) a request for IP address authorization information to a UE information repository. For example, SMF 401 may request (e.g., via an N10 interface, an Nudm interface, an Nudr interface, etc.) information such as a quantity or type (e.g., static or dynamic) of IP addresses for which UE 101 is authorized. The UE information repository may include UDM 405, a Unified Data Repository (“UDR”), or other suitable device or system that maintains or provides such information. As discussed above, different UEs may be associated with different levels of IP address authorization, such that different UEs may be authorized for different quantities or types of IP addresses.

Process 600 may additionally include receiving (at 606) the requested IP address authorization information from the UE information repository (e.g., UDM 405, the UDR, etc.). Such information may be received via the N10 interface, via an Nsmf interface, or other suitable communication pathway.

Process 600 may also include identifying (at 608) a quantity of IP addresses based on the received IP address authorization information and/or other factors. For example, SMF 401 may identify whether the requested quantity of IP addresses exceeds the IP address authorization information, and may adjust accordingly (e.g., may reduce the granted quantity of IP addresses as compared to the requested quantity). Additionally, or alternatively, SMF 401 may identify other factors, such as a total amount of available IP addresses, and may adjust the granted quantity of IP addresses based on such factors. Additionally, or alternatively, SMF 401 may grant the requested quantity of IP addresses (e.g., when the IP address authorization information indicates that the requested quantity is permissible as per UE information maintained by the UE information repository). In some embodiments, SMF 401 may communicate with one or more external authorization systems to determine the quantity of IP addresses and/or to otherwise determine whether UE 101 is authorized to receive IP addresses, in situations where the IP address authorization information includes an indication that such external authorization systems should be contacted.

Process 600 may further include providing (at 610) the IP addresses to UE 101. As discussed above, UE 101 may further assign, delegate, etc. some or all of the received IP addresses to devices that are communicatively coupled to UE 101, such as cascading routers (e.g., routers 105), other UEs, or the like.

Process 600 may additionally include configuring (at 612) one or more network elements of wireless network 103 based on the IP addresses provided to UE 101. For example, SMF 401 may provide the IP addresses to one or more UPFs 403 that are communicatively coupled to UE 101 (e.g., via one or more PDU sessions), one or more routing elements of the core network, etc. In this manner, wireless network 103 may be able to route traffic to and/or from particular devices that ultimately are assigned (e.g., by UE 101) respective IP addresses.

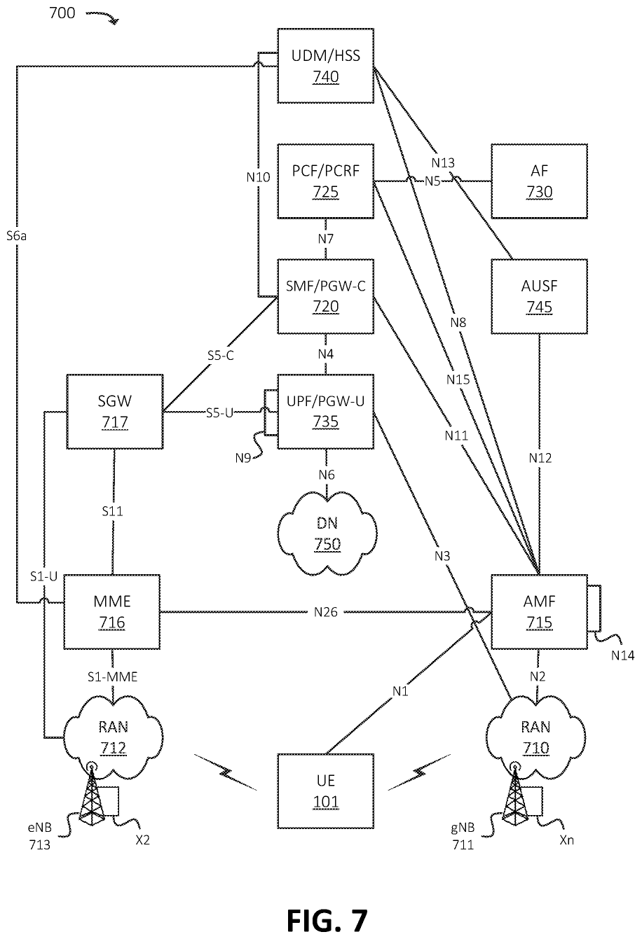

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 101, RAN 710 (which may include one or more Next Generation Node Bs (“gNBs”) 711), RAN 712 (which may include one or more evolved Node Bs (“eNBs”) 713), and various network functions such as AMF 715, Mobility Management Entity (“MME”) 716, Serving Gateway (“SGW”) 717, SMF/Packet Data Network (“PDN”) Gateway (“PGW”)-Control plane function (“PGW-C”) 720, PCF/Policy Charging and Rules Function (“PCRF”) 725, Application Function (“AF”) 730, UPF/PGW-User plane function (“PGW-U”) 735, UDM/Home Subscriber Server (“HSS”) 740, and Authentication Server Function (“AUSF”) 745. Environment 700 may also include one or more networks, such as Data Network (“DN”) 750. Environment 700 may include one or more additional devices or systems communicatively coupled to one or more networks (e.g., DN 750).

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 700 may be, may include, may be implemented by, and/or may be communicatively coupled to wireless network 103.

UE 101 may include a computation and communication device, such as a wireless mobile communication device that is capable of communicating with RAN 710, RAN 712, and/or DN 750. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, an M2M device, or the like), an FWA device, or another type of mobile computation and communication device. UE 101 may send traffic to and/or receive traffic (e.g., user plane traffic) from DN 750 via RAN 710, RAN 712, and/or UPF/PGW-U 735.

RAN 710 may be, or may include, a 5G RAN that includes one or more base stations (e.g., one or more gNBs 711), via which UE 101 may communicate with one or more other elements of environment 700. UE 101 may communicate with RAN 710 via an air interface (e.g., as provided by gNB 711). For instance, RAN 710 may receive traffic (e.g., user plane traffic such as voice call traffic, data traffic, messaging traffic, etc.) from UE 101 via the air interface, and may communicate the traffic to UPF/PGW-U 735 and/or one or more other devices or networks. Further, RAN 710 may receive signaling traffic, control plane traffic, etc. from UE 101 via the air interface, and may communicate such signaling traffic, control plane traffic, etc. to AMF 715 and/or one or more other devices or networks. Additionally, RAN 710 may receive traffic intended for UE 101 (e.g., from UPF/PGW-U 735, AMF 715, and/or one or more other devices or networks) and may communicate the traffic to UE 101 via the air interface.

RAN 712 may be, or may include, a LTE RAN that includes one or more base stations (e.g., one or more eNBs 713), via which UE 101 may communicate with one or more other elements of environment 700. UE 101 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 101 via the air interface, and may communicate the traffic to UPF/PGW-U 735 (e.g., via SGW 717) and/or one or more other devices or networks. Further, RAN 712 may receive signaling traffic, control plane traffic, etc. from UE 101 via the air interface, and may communicate such signaling traffic, control plane traffic, etc. to MME 716 and/or one or more other devices or networks. Additionally, RAN 712 may receive traffic intended for UE 101 (e.g., from UPF/PGW-U 735, MME 716, SGW 717, and/or one or more other devices or networks) and may communicate the traffic to UE 101 via the air interface.

AMF 715 may include one or more devices, systems, Virtualized Network Functions (“VNFs”), Cloud-Native Network Functions (“CNFs”), etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 101. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 101, from DN 750, and may forward the user plane data toward UE 101 (e.g., via RAN 710, SMF/PGW-C 720, and/or one or more other devices). In some embodiments, multiple instances of UPF/PGW-U 735 may be deployed (e.g., in different geographical locations), and the delivery of content to UE 101 may be coordinated via the N9 interface (e.g., as denoted in FIG. 7 by the line marked “N9” originating and terminating at UPF/PGW-U 735). Similarly, UPF/PGW-U 735 may receive traffic from UE 101 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. AUSF 745 and/or UDM/HSS 740 may perform authentication, authorization, and/or accounting operations associated with the subscriber and/or a communication session with UE 101.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 101 may communicate, through DN 750, with data servers, other UEs 101, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 101 may communicate.

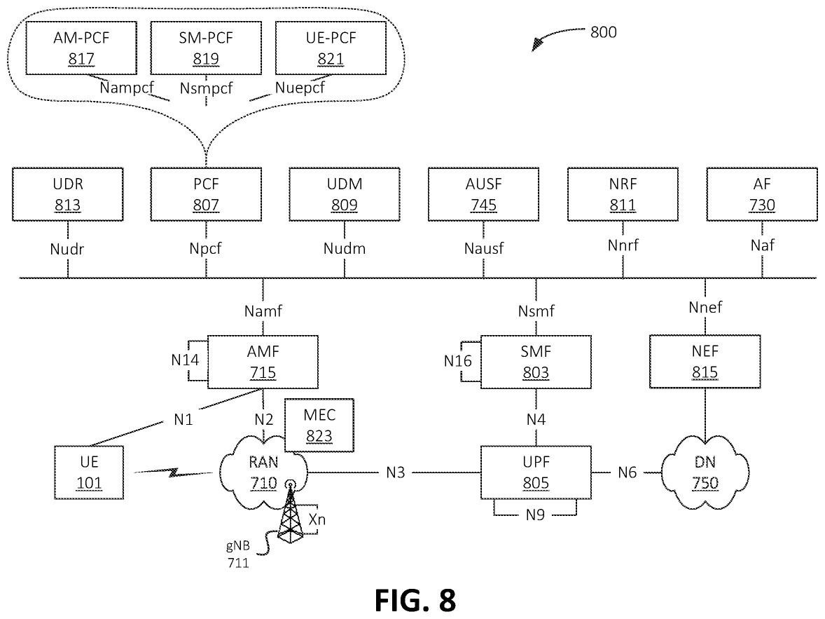

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 101, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function (“NRF”) 811, AF 730, UDR 813, and Network Exposure Function (“NEF”) 815. Environment 800 may also include or may be communicatively coupled to one or more networks, such as Data Network DN 750. The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs. In some embodiments, environment 800 may be, may include, may be implemented by, and/or may be communicatively coupled to wireless network 103.

UPF 805 may include one or more devices, systems, VNFs, CNFs, etc., that receive, route, process, and/or forward traffic (e.g., user plane traffic). As discussed above, UPF 805 may communicate with UE 101 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 101) from DN 750, and may forward the downlink user plane traffic toward UE 101 (e.g., via RAN 710). In some embodiments, multiple UPFs 805 may be deployed (e.g., in different geographical locations), and the delivery of content to UE 101 may be coordinated via the N9 interface. Similarly, UPF 805 may receive uplink traffic from UE 101 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 101 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as access and mobility PCF (“AM-PCF”) 817, session management PCF (“SM-PCF”) 819, UE PCF (“UE-PCF”) 821, and so on. Such different “split” PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 815 include one or more devices, systems, VNFs, CNFs, etc. that provide access to information, application programming interfaces (“APIs”), and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function (“CHF”) of the 5GC, and/or other suitable network function. NEF 815 may communicate with external devices or systems via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF; NEF 815 may include, may implement, may be implemented by, and/or may otherwise be associated with a Service Capability Exposure Function (“SCEF”); and so on.

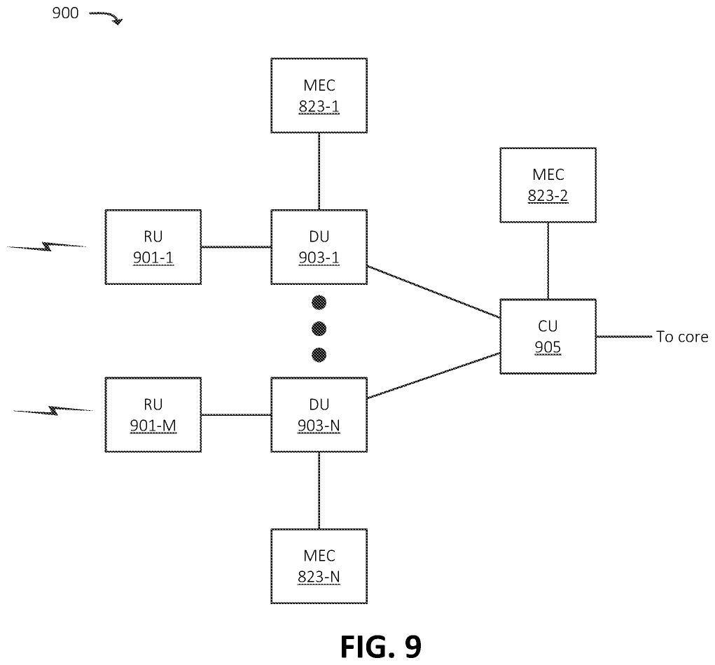

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 715 and/or UPF 805). In the uplink direction (e.g., for traffic from UEs 101 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 101, and may determine which DU(s) 903 should receive the downlink traffic. DU 903 may include one or more devices that transmit traffic between a core network (e.g., via CU 905) and UE 101 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 101.

RU 901 may include hardware circuitry (e.g., one or more RF transceivers, antennas, radios, and/or other suitable hardware) to communicate wirelessly (e.g., via an RF interface) with one or more UEs 101, one or more other DUs 903 (e.g., via RUs 901 associated with DUs 903), and/or any other suitable type of device. In the uplink direction, RU 901 may receive traffic from UE 101 and/or another DU 903 via the RF interface and may provide the traffic to DU 903. In the downlink direction, RU 901 may receive traffic from DU 903, and may provide the traffic to UE 101 and/or another DU 903.

As noted above, one or more elements of RAN environment 900 may, in some embodiments, be communicatively coupled to one or more MECs 823. For example, DU 903-1 may be communicatively coupled to MEC 823-1, DU 903-N may be communicatively coupled to MEC 823-N, CU 905 may be communicatively coupled to MEC 823-2, and so on. MECs 823 may include hardware resources (e.g., configurable or provisionable hardware resources) that may be configured to provide services and/or otherwise process traffic to and/or from UE 101, via a respective RU 901.

For example, DU 903-1 may route some traffic, from UE 101, to MEC 823-1 instead of to a core network via CU 905. MEC 823-1 may process the traffic, perform one or more computations based on the received traffic, and may provide traffic to UE 101 via RU 901-1. In some embodiments, MEC 823 may include, and/or may implement, some or all of the functionality described above with respect to UPF 805, AF 730, and/or one or more other devices, systems, VNFs, CNFs, etc. In this manner, ultra-low latency services may be provided to UE 101, as traffic does not need to traverse DU 903, CU 905, links between DU 903 and CU 905, and an intervening backhaul network between RAN environment 900 and the core network.

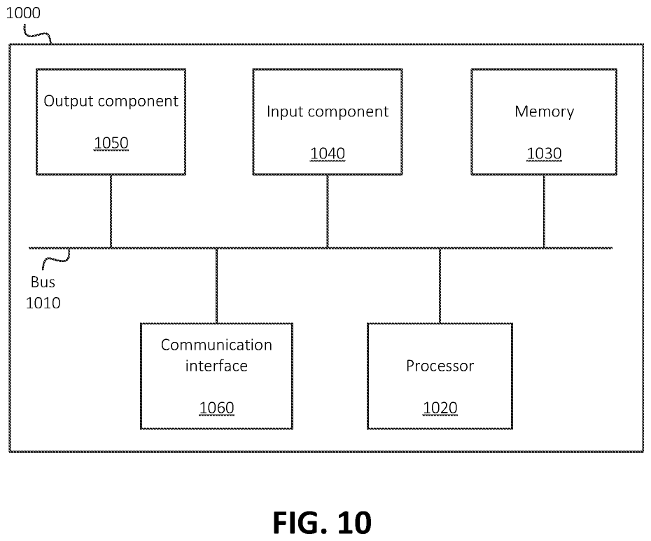

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a request to associate a particular User Equipment (“UE”) with a plurality of Internet Protocol (“IP”) addresses, wherein the UE is associated with a communication session between the UE and a core network of a wireless network;
output an information request for IP address authorization information from a UE information repository associated with the wireless network;
receive a response to the information request from the UE information repository;
identify a quantity of IP addresses based on the response to the information request; and
provide the identified quantity of IP addresses to the particular UE in response to the request to associate the particular UE with the plurality of IP addresses.

2. The device of claim 1, wherein the request to associate the particular UE with the plurality of IP addresses specifies a particular quantity, wherein the identified quantity of IP addresses is a same quantity as the particular quantity specified in the request.

3. The device of claim 1, wherein the UE information repository includes a Unified Data Management function (“UDM”).

4. The device of claim 1, wherein outputting the information request includes outputting the information request via an N10 interface.

5. The device of claim 1, wherein the device includes a Session Management Function (“SMF”) of the wireless network.

6. The device of claim 1, wherein the request to associate the particular UE with a plurality of IP addresses includes an IP prefix delegation request.

7. The device of claim 1, wherein identifying the particular quantity of IP addresses includes identifying at least one of:
a quantity of IP prefixes, or
an IP prefix length.

8. A non-transitory computer-readable medium, storing a plurality of processor-executable instructions to:
receive a request to associate a particular User Equipment (“UE”) with a plurality of Internet Protocol (“IP”) addresses, wherein the UE is associated with a communication session between the UE and a core network of a wireless network;
output an information request for IP address authorization information from a UE information repository associated with the wireless network;
receive a response to the information request from the UE information repository;
identify a quantity of IP addresses based on the response to the information request; and
provide the identified quantity of IP addresses to the particular UE in response to the request to associate the particular UE with the plurality of IP addresses.

9. The non-transitory computer-readable medium of claim 8, wherein the request to associate the particular UE with the plurality of IP addresses specifies a particular quantity, wherein the identified quantity of IP addresses is a same quantity as the particular quantity specified in the request.

10. The non-transitory computer-readable medium of claim 8, wherein the UE information repository includes a Unified Data Management function (“UDM”).

11. The non-transitory computer-readable medium of claim 8, wherein outputting the information request includes outputting the information request via an N10 interface.

12. The non-transitory computer-readable medium of claim 8, wherein receiving the request to associate the particular UE with the plurality of IP addresses, outputting the information request, and receiving the response to the information request are performed by a Session Management Function (“SMF”) of the wireless network.

13. The non-transitory computer-readable medium of claim 8, wherein the request to associate the particular UE with a plurality of IP addresses includes an IP prefix delegation request.

14. The non-transitory computer-readable medium of claim 8, wherein identifying the particular quantity of IP addresses includes identifying at least one of:
a quantity of IP prefixes, or
an IP prefix length.

15. A method, comprising:
receiving a request to associate a particular User Equipment (“UE”) with a plurality of Internet Protocol (“IP”) addresses, wherein the UE is associated with a communication session between the UE and a core network of a wireless network;
outputting an information request for IP address authorization information from a UE information repository associated with the wireless network;
receiving a response to the information request from the UE information repository;
identifying a quantity of IP addresses based on the response to the information request; and
providing the identified quantity of IP addresses to the particular UE in response to the request to associate the particular UE with the plurality of IP addresses.

16. The method of claim 15, wherein the request to associate the particular UE with the plurality of IP addresses specifies a particular quantity, wherein the identified quantity of IP addresses is a same quantity as the particular quantity specified in the request.

17. The method of claim 15, wherein the UE information repository includes a Unified Data Management function (“UDM”), and wherein outputting the information request includes outputting the information request via an N10 interface.

18. The method of claim 15, wherein receiving the request to associate the particular UE with the plurality of IP addresses, outputting the information request, and receiving the response to the information request are performed by a Session Management Function (“SMF”) of the wireless network.

19. The method of claim 15, wherein the request to associate the particular UE with a plurality of IP addresses includes an IP prefix delegation request.

20. The method of claim 15, wherein identifying the particular quantity of IP addresses includes identifying at least one of:
a quantity of IP prefixes, or
an IP prefix length.
